(19) United States
(12) Patent Application Publication
(10) Pub. No.: US 2025/0005101 A1
(43) Pub. Date: Jan. 2, 2025

(54) TECHNIQUES FOR TWIDDLE FACTOR GENERATION FOR NUMBER-THEORETIC- TRANSROM AND INVERSE-NUMBER-THEORETIC-TRANFORM COMPUTATIONS

(71) Applicant: Intel Corporation, Santa Clara, CA (US)

(72) Inventors: Sachin TANEJA, Hillsboro, OR (US); Sanu K. MATHEW, Portland, OR (US); Raghavan KUMAR, Hillsboro, OR (US); Nojan SHEYBANI, San Diego, CA (US); Vikram B. SURESH, Portland, OR (US)

(21) Appl. No.: 18/217,565

(22) Filed: Jul. 1, 2023

(51) Int. Cl. G06F 17/14

(52) U.S. Cl. CPC G06F 17/14

(57) ABSTRACT

Examples include techniques for twiddle factor generation for number-theoretic-transform (NTT) or inverse-NTT (iNTT) computations by a compute element. The compute element can be included in a parallel processing device. Examples include receiving information to generate a twiddle factor for use by the compute element to execute an NTT or an iNTT computation for an N-degree polynomial, obtain data for a power of 2 of a root of unity from a memory resident on a same chip or die as the compute element and generate the twiddle factor using the obtained data based, at least in part, on the received information.

### STATEMENT REGARDING FEDERALLY SPONSORED RESEARCH

This invention was made with Government support under contract number HR0011-21-3-0003-0104 awarded by the Department of Defense. The Government has certain rights in this invention.

### TECHNICAL FIELD

Examples described herein are generally related to techniques associated with twiddle factor generation for number-theoretic transform (NTT) and inverse-NTT (iNTT) computations by a parallel processing device for fully homomorphic encryption (FHE) workloads or operations.

### BACKGROUND

Number-theoretic-transforms (NTT) and inverse-NTT (iNTT) are important operations for accelerating fully homomorphic encryption (FHE) workloads. NTT/INTT computations/operations can be used to reduce runtime complexity of polynomial multiplications associated with FHE workloads from O(n²) to O(n log n), where n is the degree of the underlying polynomials. NTT/iNTT operations can convert polynomial ring operands into their Chinese-remainder-theorem equivalents, allowing coefficient-wise multiplications to speed up polynomial multiplication operations. NTT and iNTT operations can be mapped for execution by computational elements included in a parallel processing device. The parallel processing device could be referred to as a type of accelerator device to accelerate execution of FHE workloads.

### BRIEF DESCRIPTION OF THE DRAWINGS

FIG. 1 illustrates an example system.

FIG. 2 illustrates an example NTT network.

FIG. 3 illustrates examples of twiddle-factor metadata.

FIG. 4 illustrates an example decimation-in-time (DiT) data flows for twiddle factor powers.

FIG. 5 illustrates example decimation-in-frequency (DiF) data flows for twiddle factor powers.

FIG. 6 illustrates an example first twiddle factor generator scheme.

FIG. 7 illustrates an example twiddle factor NTT/iNTT instruction format.

FIG. 8 illustrates an example second twiddle factor generator scheme.

FIG. 9 illustrates an example logic flow.

FIG. 10 illustrates an example computing system.

FIG. 11 illustrates a block diagram of an example processor and/or System on a Chip (SoC) that may have one or more cores and an integrated memory controller.

### DETAILED DESCRIPTION

In some examples, NTT and iNTT operations can be mapped for execution by computational elements included in a parallel processing device. The parallel processing device may include reconfigurable compute elements such reconfigurable butterfly circuits. These reconfigurable butterfly circuits can be arranged in separate groups organized in a plurality of tiles. These butterfly circuits can perform single instruction, multiple data (SIMD) add, multiply, multiply-and-accumulate, subtraction, etc.

According to some examples, an NTT/iNTT of an n-degree polynomial is computed using a logarithmic network similar to a fast Fourier transform (FFT) network where polynomial coefficients are presented as inputs to the network. A parallel processing device can include butterfly circuits arranged in nodes of an NTT network (e.g., decimation-in-time (DiT) network) For example, an NTT operation arrangement for an N-degree polynomial requires LOG(2,N) stages with N/2 butterfly circuits at each stage. Each butterfly circuit of a node can perform a modular multiply-add operations of a pair of coefficients along with a constant value of ω, known as the twiddle factor. Twiddle factors are computed as various powers of a root of unity (ω⁰ ω¹, . . . ω^{n/2-2} ω^{n/2-1}). Similarly, inverse counterparts of these constants (ω⁻¹, . . . ω^{-n/2-2} ω^{-n/2-1}) can be used during an inverse NTT operation.

As twiddle factors are constants that do not depend on user data, they are typically streamed into a chip for a parallel processing device by the user during bootup of the parallel processing device. However, an on-die or on-chip storage footprint or memory capacity needed for these constants can be substantial. For example, an NTT/iNTT operation for a 16,384-degree (16K-degree) polynomial can require around 12 megabytes (MBs) of on-die memory capacity to store twiddle factors streamed into the chip. Streaming in the twiddle factors also consumes memory/IO bandwidth. This disclosure includes examples of how to minimize on-die memory capacity needed for twiddle factors used in NTT/iNTT operations by generating twiddle factors based on metadata just-in-time for NTT/iNTT computations.

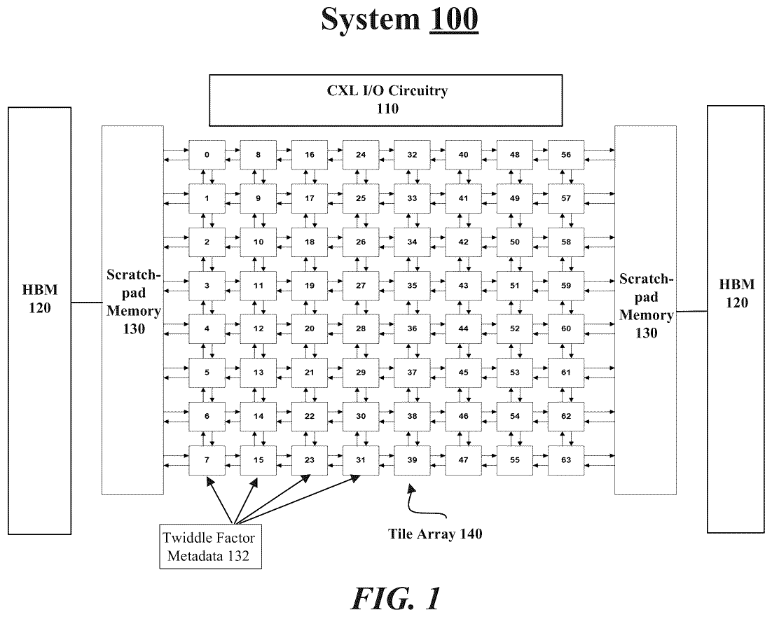

FIG. 1 illustrates an example system 100. In some examples, system 100 can be included in and/or operate within a compute platform. The compute platform, for example, could be located in a data center included in, for example, cloud computing infrastructure, examples are not limited to system 100 included in a compute platform located in a data center. As shown in FIG. 1, system 100 includes compute express link (CXL) input/output (I/O) circuitry 110, high bandwidth memory (HBM) 120, scratchpad memory 130 or tile array 140.

In some examples, system 100 can be configured as a parallel processing device or accelerator to perform NTT/iNTT operations/computations for accelerating FHE workloads. For these examples, CXL I/O circuitry 110 can be configured to couple with one or more host central processing units (CPUs—not shown) to receive instructions and/or data via circuitry designed to operate in compliance with one or more CXL specifications published by the CXL Consortium to included, but not limited to, CXL Specification, Rev. 2.0, Ver. 1.0, published Oct. 26, 2020, or CXL Specification, Rev. 3.0, Ver. 1.0, published Aug. 1, 2022. Also, CXL I/O circuitry 110 can be configured to enable one or more host CPUs to obtain data associated with execution of accelerated FHE workloads by compute elements included in interconnected tiles of tile array 140. For example, data (e.g., ciphertext or processed ciphertext) may be received to or pulled from HBM 120 and CXL I/O circuitry 110 can facilitate the data movement into or out of HBM 120 as part of execution of accelerated FHE workloads. Also, scratchpad memory 130 can be a type of memory (e.g., register files) that can be proportionately allocated to tiles included in tile array 140 to facilitate execution of the accelerated FHE workloads and to perform NTT/iNTT operations/computations.

In some examples, tile array 140 can be arranged in an 8×8 tile configuration as shown in FIG. 1 that includes tiles 0 to 63. For these examples, each tile can include, but is not limited to, 128 compute elements (not shown in FIG. 1) and local memory (e.g., register files) to store the input operands and results of operations/computations. The 128 compute elements can be 128 separately reconfigurable butterfly circuits, that are configured to compute output terms associated with polynomial coefficients for NTT/INTT operations/computations. As shown in FIG. 1, tiles 0 to 63 can be interconnected via point-to-point connections via a 2-dimensional (2D) mesh interconnect-based architecture. The 2D mesh enables communications between adjacent tiles using single-hop links, as one example of an interconnect-based architecture, examples are not limited to 2D mesh.

According to some examples, as described in more detail below, twiddle factors used at each stage (e.g., at each tile) can be generated for an N-degree polynomial based on twiddle metadata stored on die or on chip. For example, the twiddle metadata can be included in twiddle factor metadata 132 maintained in every tile within tile array. FIG. 1 shows only four arrows pointing from twiddle factor metadata 132 for simplicity purposes. The twiddle factor metadata, for example, includes power of 2 of the root of unity (ω^{2p}) and can be loaded or stored to twiddle factor metadata 132 maintained in every tile within tile array 140 during bootup or initialization of system 100, where p is any positive or negative integer. For example, if twiddle factor metadata entries included in twiddle factor metadata 132 is 512 bits for each ω, a 16K-degree polynomial would need about 1.8 kilobytes (KBs) of memory capacity to store all power of 2 twiddle factors for the 16K-degree polynomial. 1.8 KBs is substantially smaller than the 12 MBs of memory mentioned above for storing all twiddle factors for a 16-K degree polynomial in on die or on chip memory.

Examples are not limited to use of CXL I/O circuitry such as CXL I/O circuitry 110 to facilitate receiving instructions and/or data or providing executed results associated with FHE workloads. Other types of I/O circuitry and/or additional circuitry to receive instructions and/or data or provide executed results are contemplated. For example, the other types of I/O circuitry can support protocols associated with communication links such as Infinity Fabric® I/O links configured for use, for example, by AMD® processors and/or accelerators or NVLink™ I/O links configured to use, for example, by Nvidia® processors and/or accelerators.

Examples are not limited to HBM such as HBM 120 for receiving data to be processed or to store information associated with instructions to execute an FHE workload or execution results of the FHE workload. Other types of volatile memory or non-volatile memory are contemplated for use in system 100. Other type of volatile memory can include, but are not limited to, Dynamic RAM (DRAM), DDR synchronous dynamic RAM (DDR SDRAM), GDDR, static random-access memory (SRAM), thyristor RAM (T-RAM) or zero-capacitor RAM (Z-RAM). Non-volatile types of memory can include byte or block addressable types of non-volatile memory such as, but not limited to, multi-threshold level NAND flash memory, NOR flash memory, single or multi-level phase change memory (PCM), resistive memory, nanowire memory, ferroelectric transistor random access memory (FeTRAM), anti-ferroelectric memory, resistive memory including a metal oxide base, an oxygen vacancy base and a conductive bridge random access memory (CB-RAM), a spintronic magnetic junction memory, a magnetic tunneling junction (MTJ) memory, a domain wall (DW) and spin orbit transfer (SOT) memory, a thyristor based memory, a magnetoresistive random access memory (MRAM) that incorporates memristor technology, spin transfer torque MRAM (STT-MRAM), or a combination of any of the above.

According to some examples, system 100 can be included in a system-on-a-chip (SoC). An SoC is a term often used to describe a device or system having a compute elements and associated circuitry (e.g., I/O circuitry, butterfly circuits, power delivery circuitry, memory controller circuitry, memory circuitry, etc.) integrated monolithically into a single integrated circuit (“IC”) die, or chip. For example, a device, computing platform or computing system could have one or more compute elements (e.g., butterfly circuits) and associated circuitry (e.g., I/O circuitry, power delivery circuitry, memory controller circuitry, memory circuitry, etc.) arranged in a disaggregated collection of discrete dies, tiles and/or chiplets (e.g., one or more discrete compute die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

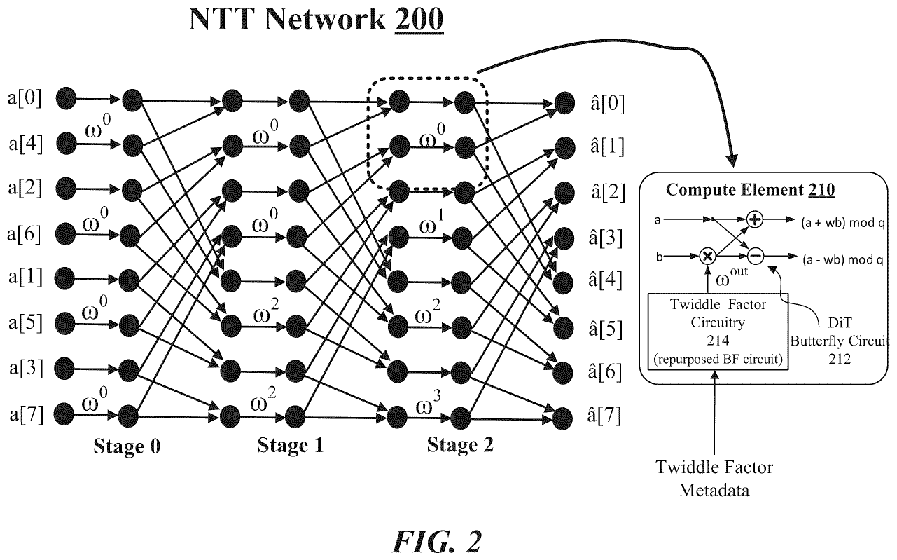

FIG. 2 illustrates an example NTT network 200. According to some examples, NTT network 200, as shown in FIG. 2, includes 3 stages of nodes, each node to include a compute element 210. For these examples, each compute element 210 includes a decimation-in-time (DiT) butterfly circuit 212 configured to execute at least NTT operations and may also be configured to execute iNTT operations for an N-degree polynomial. Other types of butterfly circuits such as decimation-in-frequency (DiF) butterfly circuits are contemplated, so examples are not limited to DiT butterfly circuits.

According to some example, NTT network 200, is for an N-degree polynomial, where N=8 (8-degree polynomial). So an 8-degree polynomial requires LOG (2,8)=3 stages with 8/2=4 compute elements 210 at each stage. Polynomial coefficients shown on the left side of NTT network 200 in FIG. 2 (a[0] . . . a[7]) are presented as inputs to NTT network 200. At each node of NTT network 200, separate DiT butterfly circuits 212 included in compute elements 210 perform a modular multiply-add operation of a pair of coefficients along with a twiddle factor ω^{out}. As briefly mentioned above, twiddle factors ω used at each stage can be generated based on twiddle factor metadata stored on a die or chip that includes compute element 210. For example, as describe more below, a twiddle factor circuitry 214 included in each compute element 210 can be repurposed as a multiplier using a dedicated instruction as twiddle factor circuitry to generate a ω^{out} based, at least in part, on twiddle metadata (e.g., stored on die) for use by DiT butterfly circuit 212 to perform the modular multiply-add operations of the pair of coefficients for NTT/iNTT.

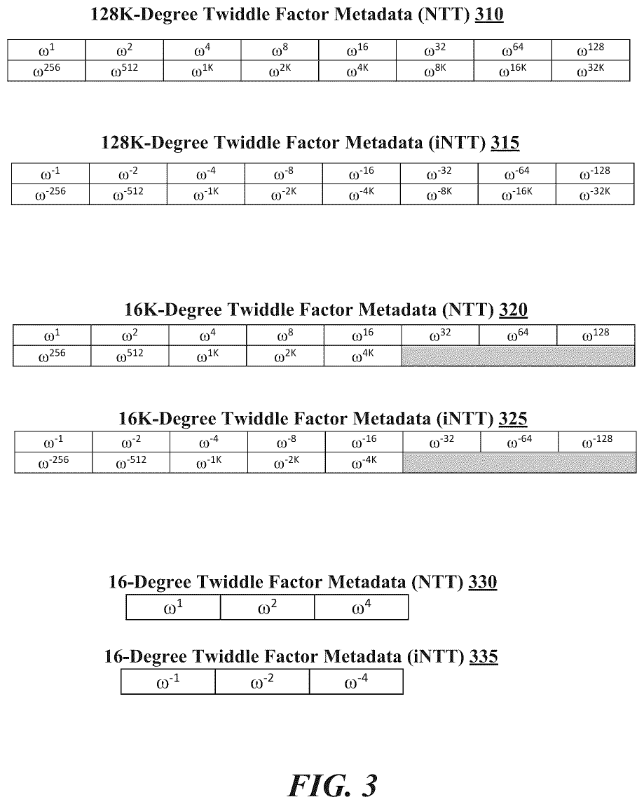

FIG. 3 illustrates examples of twiddle factor metadata for polynomials of various degrees. For example, as shown in FIG. 3, 131,072-degree (128K-degree), 16K-degree and 16-degree twiddle factor metadata for NTT or iNTT operations are shown. 128K-degree polynomial NTT or iNTT operations require appropriate twiddle factors ω, ω² . . . ω^{32K} to be multiplied with polynomial coefficients at various stages of an NTT or iNTT operation executed by compute elements configured in a similar manner as mentioned above for NTT network 200 shown in FIG. 2. As mentioned above for a 16K-degree polynomial and to an even greater amount for 128K-degree polynomial, storage of all these twiddle factors, if stored on die or on chip, can require a substantial amount of storage or memory capacity and/or consume a large amount of memory/IO bandwidth if all twiddle factors are streamed from an off die or off chip memory source.

In some examples, 128K-degree twiddle factor metadata (NTT) 310 and 128K-degree twiddle factor metadata (iNTT) 315 show an example of including only powers of 2 for the root of unity (ω^{2p}) to be stored on die or on chip. So rather than storing around 64K twiddle factors for NTT operations as well another 64K twiddle factors for iNTT operations, only 16×2=32 entries are included in NTT/iNTT twiddle factor metadata to be stored on die or on chip. Similarly, 16K-degree twiddle factor metadata (NTT) 320 and 16K-degree twiddle factor metadata (INTT) 325 show 13×2=26 entries and 16-degree twiddle factor metadata (NTT) 330 and 16-degree twiddle factor metadata (INTT) 335 show 3×2=6 entries.

According to some examples, a simplified example of how twiddle factor circuitry coupled with or at a compute element (e.g., twiddle factor circuitry 214) can use 16-degree twiddle factor metadata included in 16-degree twiddle factor metadata (NTT) 330 or 16-degree twiddle factor metadata (iNTT) 335 to generate a ω^{out} to be used by a butterfly circuit at the compute element in an NTT/iNTT operation.

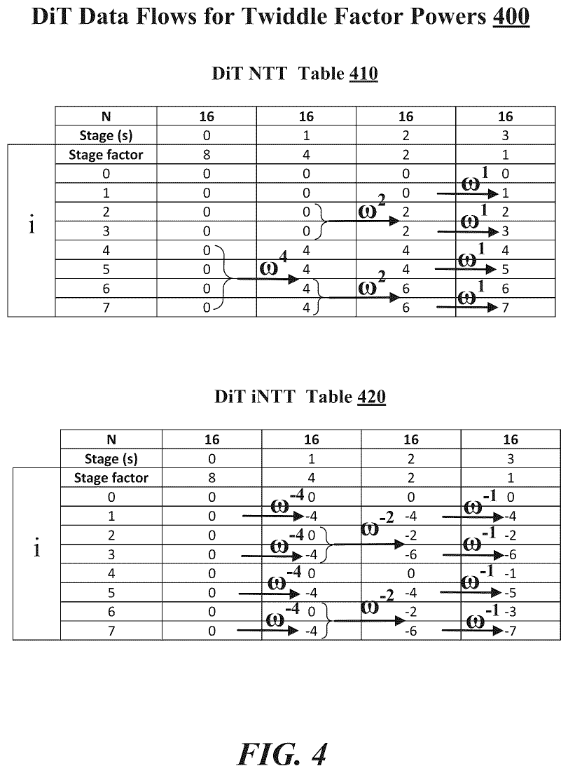

FIG. 4 illustrates example DiT data flows for twiddle factor powers 400. According to some examples, DiT data flows for twiddle factor powers 400 are associated with 16-degree polynomial NTT or iNTT operations for DiT configured butterfly circuits that includes 4 sequential stages. The 4 sequential stages are shown in row #2 of DiT NTT table 410 and DiT iNTT table 420 of FIG. 4 as stages 0-3. Also as shown in row #3 of these two table is a stage factor. For these examples, a stage factor is determined based on 2^{LOG(N,2)-1-s}, where N is polynomial size or degree and s is current stage number for an NTT or iNTT operation. So for a 16-degree polynomial at stage 0, stage factor=2 Log (2,16)−1−0=2⁴⁻¹=8 and stage factors for stage 1, 2 and 3 are 4, 2, 1, respectively. Also, an index #(i=0 . . . 7) of a butterfly circuit of a compute element can be used to determine a specific power of ω that is to be multiplied during twiddle factor generation by twiddle factor circuitry to generate a twiddle factor to be used by the butterfly circuit for an NTT or an iNTT computation. Responsive to a 1-bit update signal, twiddle factor circuitry can be configured to generate a twiddle factor to be used by the butterfly circuit, in real time, using the index # and stage # to determine the specific power of ω to use to generate or calculate the twiddle factor at each butterfly circuit. Example equation 1 can be used to calculate the updated twiddle factor:

$$if ( update [ i ] == 1 ) {ω}^{out} = \{ {ω}^{i n} X {ω}^{n} \} else {ω}^{out} = \{ {ω}^{i n} X {ω}^{0} \} \qquad ( 1 )$$

For example equation 1, ω^{out} is the twiddle factor generated/calculated by twiddle factor circuitry, ωⁱⁿ is a twiddle factor used by butterfly circuits in the previous stage (previously generated) and ωⁿ represents the twiddle factor pulled from NTT twiddle factor metadata stored on die (e.g., 16-degree twiddle factor metadata 330), where “n” is based on the calculated stage factor.

According to some examples, as shown in FIG. 4 for DiT NTT table 410, one or more twiddle factors for any stage of an NTT operation can be generated, responsive to an index update signal, by combining a previous stage twiddle factor with a specific power of ω that is dependent on a current stage number. For example, DiT NTT table 410 shows that stage 0 starts with all zero powers for ωⁱⁿ. Twiddle factors for stage 1 can be derived from stage 0 by multiplication with ω⁴ in some targeted location (lower half corresponding to rows for i=4-7). Data for ω⁴ can be obtained from twiddle metadata (e.g., 16-degree twiddle factor metadata 330) stored on die. So as shown in FIG. 4 for DiT NTT table 410, ωⁱⁿ=ω⁰ for butterfly circuits with i=4-7, and ω⁰ is multiplied with ω⁴ to calculate a stage 1 ω^{out} power of 4 (e.g., ω^{out}=ω⁰×ω⁴=ω⁴) to be used as a twiddle factor at stage 1 for the i=4-7 butterfly circuits, and i=0-3 butterfly circuits will continue to use a twiddle factor of ω⁰. Then to calculate twiddle factors to use at stage 2, ωⁱⁿ=ω⁰ for i=0-3 butterfly circuits and ωⁱⁿ=ω⁴ for i=4-7 butterfly circuits. For stage 2, the stage specific factor changes to 2. So ωⁿ is ω², and as shown in FIG. 1 a stage 1 ω^{out} power of 2 is calculated for twiddle factors to use for i=2,3 butterfly circuits, a ω^{out} power of 6 is calculated for twiddle factors to use for i=6,7 butterfly circuits, i=0,1 butterfly circuits will continue to use a twiddle factor of ω⁰, and i=4,5 butterfly circuits will continue to use a twiddle factor of ω⁴. Finally, to calculate twiddle factors to use at stage 3, ωⁱⁿ=ω⁰ for i=0,1 butterfly circuits, ωⁱⁿ=ω² for i=2,3 butterfly circuits, ωⁱⁿ=04 for i=4,5 butterfly circuits and ωⁱⁿ=ω⁶ for i=6,7 butterfly circuits. For stage 3, the stage specific factor changes to 1. So ωⁿ is ω¹, and as shown in FIG. 4, a stage 3 ω^{out} power of 1 is calculated for a twiddle factor to use for i=1 butterfly circuit, a ω^{out} power of 3 is calculated for a twiddle factor to use for i=3 butterfly circuit, a ω^{out} power of 5 is calculated for a twiddle factor to use for i=5 butterfly circuit, a ωₒᵤₜ power of 7 is calculated for a twiddle factor to use for i=7 butterfly circuit. Also, for stage 3, the i=0 butterfly circuit will continue to use a twiddle factor of ω⁰, the i=2 butterfly circuit will continue to use a twiddle factor of ω², the i=4 butterfly circuit will continue to use a twiddle factor of ω⁴, and the i=6 butterfly circuit will continue to use a twiddle factor of ω⁶.

In some examples, DiT iNTT table 420 requires the same inverse powers starting from all zeros to all inverse powers (e.g., ω⁰ . . . ω⁻⁷). For these examples, an inverse of stage-specific power can be determined based on −2^{LOG(N,2)-1-s}, where N is polynomial size or degree and s is current stage. A similar process is then implemented as mentioned above for DIT NTT table 410 to move from all zero powers to all inverse powers. Stage-specific power (e.g., ω⁻ⁿ) twiddle factors can be pulled from iNTT twiddle factor metadata stored on die (e.g., 16-degree twiddle factor metadata 335).

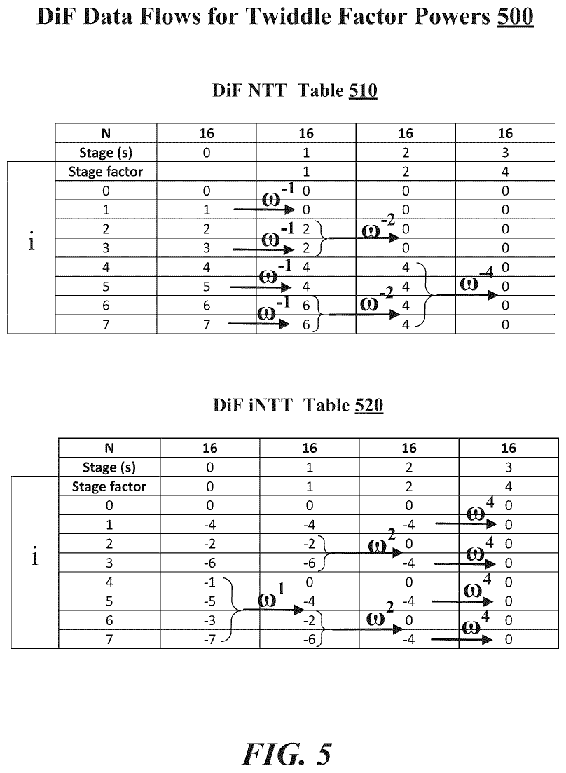

FIG. 5 illustrates example DiF data flows for twiddle factor powers 500. According to some examples, DiF data flows 500 are associated with 16-degree polynomial NTT/iNTT operations for DiF configured butterfly circuits that includes 4 stages. The 4 stages are shown in row #2 of DiF NTT table 510 and DiF iNTT table 520 of FIG. 5 as stages 0-3. Different than DiF NTT data flows mentioned above for FIG. 4, DiF data flows for twiddle factor powers 500 require all twiddle power factors during a first stage (stage 0) and requires fewer twiddle power factors as DiF data flows for twiddle factor powers 500 progresses through stages 0-3. As shown in FIG. 5 for DiF NTT table 510, DiF NTT twiddle factors can be generated using the DIT NTT table 410 final stage twiddle factors mentioned above for DiT data flows for twiddle factor powers for twiddle factor powers 400. Then as shown in DiF NTT table 510 and DiF iNTT table 520, starting with stage 0 twiddle factors and multiplication with inverse of stage-specific twiddle factors progress towards all zero powers. These DiF NTT/iNTT options can be suitable for memory limited scenarios where only one memory location is utilized to read a current stage twiddle factor (ωⁱⁿ) and overwrite the next state twiddle factor (ω^{out}) on the same memory location. In cases of ample or greater memory availability, to store twiddle factors for all the stages, DIT NTT/iNTT twiddle factors for all stages can be generated upfront and can be accessed in reverse order for DiF NTT/iNTT. According to some examples, stage-specific powers (ωⁿ or ω⁻ⁿ) used to calculate twiddle factors can be obtained, from a memory location that includes 16-degree twiddle factor metadata 330 for NTT operations or 16-degree twiddle factor metadata 335 for iNTT operations.

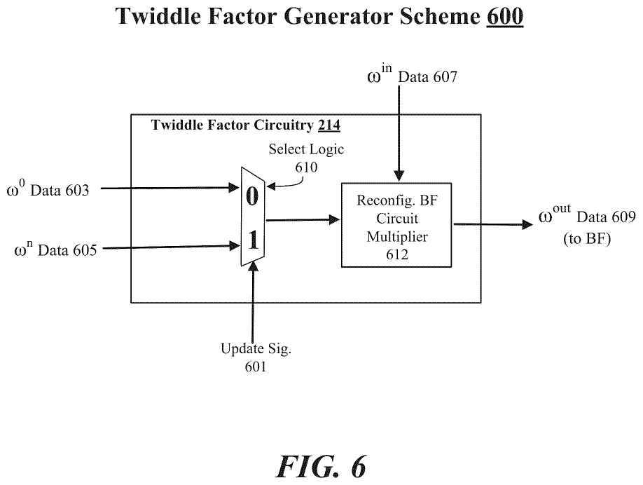

FIG. 6 illustrates a twiddle factor generator scheme 600. According to some examples, twiddle factor generator scheme 600 can be implemented to generate twiddle factors in real-time by twiddle factor circuitry 214 for each stage of an NTT operation or an iNTT operation at each tile of an array of compute elements such as tile array 140 shown in FIG. 4. For these examples, as shown in FIG. 6, twiddle factor circuitry 214 includes a select logic 610 and a reconfigured butterfly (BF) circuit as multiplier 612. The reconfigured BF circuit as multiplier 612, for example, can be a repurposed butterfly circuit such as DiT butterfly circuit 212 shown in FIG. 2 that is reconfigured as a multiplier to generate a twiddle factor. Based on a 1-bit update signal 601 indicating an index update, update logic 610 selects whether to cause ω⁰ data 603 or ωⁿ data 605 to be multiplied with ωⁱⁿ data 607 by reconfigured BF circuit as multiplier 612 to generate ω^{out} data 609. For example, a 1-bit value of “1” received via update signal 601 causes select logic 610 to select ωⁿ data 605 or a 1-bit value of “0” causes select logic 610 to select ω⁰ data 603. Reconfigured BF circuit multiplier 612 then multiples either ω⁰ data 603 or ωⁿ data 605 with ωⁱⁿ data 607 to generate ω^{out} data 609 (e.g., see example equation 1). ω^{out} data 609 can then be used by the butterfly circuit (BF) attached to twiddle factor circuitry 214 to execute an NTT/INTT computation or operation.

According to some examples, ω⁰ data 603, ωⁿ data 605, ωⁱⁿ data 607 can be fetched from twiddle factor metadata stored on die. For example, if a 16K-degree polynomial is being used for NTT operations, data associated with an appropriate power of ω can be fetched from memory addresses that store the entries for 16K-degree twiddle factor metadata 320 shown in FIG. 3.

In some examples, rather than repurpose an existing BF circuit to be used for reconfigured BF circuit multiplier 612, additional butterfly logic/circuitry can be added to multiple ω⁰/ωⁿ with ωⁱⁿ to generate ω^{out}. This alternative configuration of twiddle factor circuitry 214 would come at the cost of higher die or chip area that would need to be added to accommodate for this additional butterfly logic/circuitry.

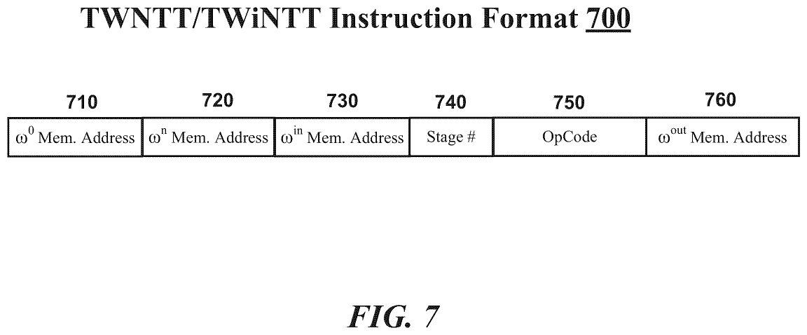

FIG. 7 illustrates an example TWNTT/TWiNTT instruction format 700. In some examples, as shown in FIG. 7, example TWNTT/TWiNTT instruction format 700 includes a ω⁰ memory address field 710, a ωⁿ memory address field 720, a ωⁱⁿ memory address field 730, a stage # field 740, an OpCode field 750, or a ω^{out} memory address field 760. In some examples, memory addresses for fetching ω⁰ data 603, ωⁿ data 605, ωⁱⁿ data 607 as well as a memory address for ω^{out} data 609 as shown in FIG. 6 can be provided for use by twiddle factor circuitry 214 in respective 0° memory address field 710, ωⁿ memory address field 720, ωⁱⁿ memory address field 730, and ω^{out} memory address field 760. Meanwhile stage # field 740 can indicate a stage number of an NTT/iNTT operation for which a twiddle factor is to be generated and OpCode field 750 can indicate what operation to perform to generate a ω^{out} (e.g., implement example equation 1).

According to some examples, a twiddle factor NTT/iNTT instruction in the example of TWNTT/TWiNTT instruction format 700 could be sent to controller circuitry at each tile of a tile array of compute elements or to controller circuitry communicatively coupled with all tiles of the tile array. The controller circuitry, responsive to the NTT/iNTT instruction, can also generate the 1-bit update signal 601 used by select logic 610 as mentioned above for FIG. 6. The TWNTT/TWiNTT instruction, for example, can be added to an instruction set architecture (ISA) for controlling a parallel processing device that includes the tile array to enable real time generation of twiddle factor constants for NTT/iNTT operations based on a reduced number of twiddle factors that are stored on die.

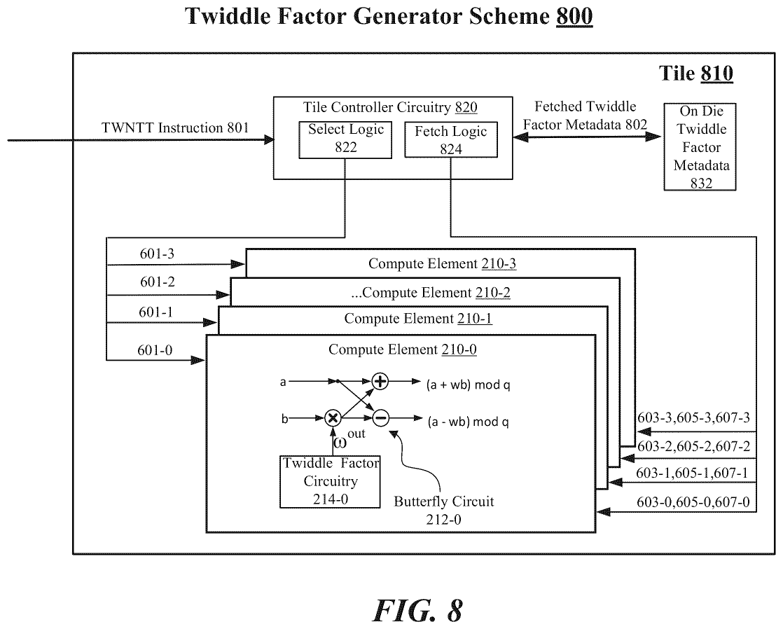

FIG. 8 illustrates an example twiddle factor generator scheme 800. In some examples, as shown in FIG. 8, a tile 810 includes four compute elements 210-0- to 210-3. For these examples, compute elements 210-0 to 210-3 of tile 810 can be arranged to execute a stage for an NTT operation in an NTT network such as NTT network 200 shown in FIG. 2. Tile 810 is also shown in FIG. 8 as including tile controller circuitry 820 that has a select logic 822 and a fetch logic 824. Examples are not limited to NTT operations, iNTT operations can also be implemented in a similar manner.

According to some examples, a TWNTT Instruction 801 (e.g., in the example TWNTT/TWiNTT instruction format 700) is provided to tile controller circuitry 820. For these examples, based on the information included in TWNTT instruction 801 fetch logic 824 obtains or fetches ω⁰, ωⁿ, ωⁱⁿ and sends the data for these twiddle factors to compute elements 210-0-210-3 for use by each compute element's respective twiddle factor circuitry. FIG. 8 shows separate 603, 605, 607 to each compute element to represent the sending of fetched twiddle factors data to each compute element's twiddle factor circuitry. Also, based on the stage # indicated in the TWNTT instruction 801, select logic 822 sends update signals 601 to each compute element for their respective twiddle factor circuitry to use to decide whether to use ω⁰ or ωⁿ to generate ω^{out}.

In some examples, twiddle factor circuitry 214, rather than being included in/with separate compute elements 210, can be part of tile controller circuitry 820. As part of tile controller circuitry 820, twiddle factor circuitry 214 can be arranged to generate and send ω^{out} to each compute element for use in an NTT operation associated with the stage # indicated in the TWNTT instruction 800. For example, twiddle factor circuitry 214-0 to 214-3 can generate ω^{out} data 609 and send to respective compute elements 210-0 to 210-3 for use in the NTT operation.

According to some examples, tile controller circuitry 820 and/or twiddle factor circuitry 214 can be processor circuitry, a field programmable gate array (FPGA) or a portion of a processor circuitry or a portion of an FPGA.

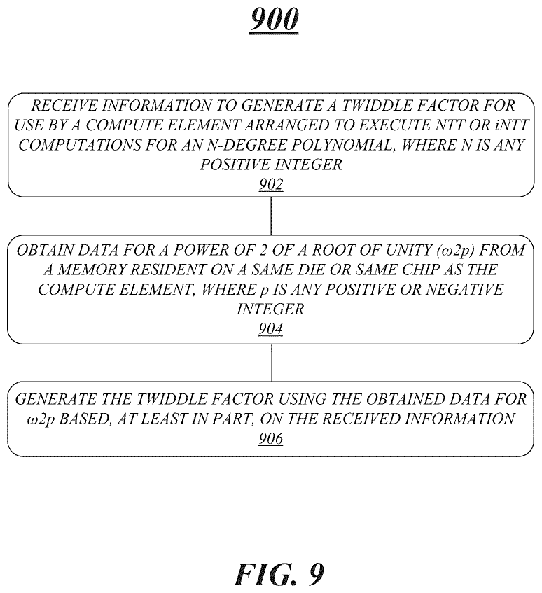

FIG. 9 illustrates an example logic flow 900. Logic flow 900 is representative of the operations implemented by logic and/or features of circuitry included in or coupled with a compute element such as twiddle factor circuitry 214 included with compute element 210 as shown in FIG. 2 or 8 or tile controller circuitry of a tile that includes the compute element such as tile controller circuitry 820 of tile 810 as shown in FIG. 8. The compute element, twiddle factor circuitry, tile controller circuitry or the tile can be resident on a same die or same chip as a memory such as portion of memory (e.g., included in scratchpad memory 130) that is allocated to a tile (e.g., a register file for a tile included in tile array 140) arranged to store twiddle factor metadata such as twiddle factor metadata 132 shown in FIG. 1 or on die twiddle factor metadata 832 shown in FIG. 8.

In some examples, as shown in FIG. 9, logic flow 900 at block 902 can receive information to generate a twiddle factor for use by a compute element arranged to execute NTT or iNTT computations for an N-degree polynomial, where N is any positive integer. For these examples, the information can be included in an instruction sent to at least a tile controller circuitry such as tile controller circuitry 820 or possibly directly to twiddle factor circuitry coupled with the compute element such as twiddle factor circuitry 214.

According to some examples, logic flow 900 at 904 can obtain data for a power of 2 of a root of unity (ω^{2p}) from a memory resident on a same die or same chip as the compute element, where p is any positive or negative integer. For these examples, data for ω^{2p} can be maintained in twiddle factor metadata such as twiddle factor metadata 132 or on die twiddle factor metadata 832. The data for ω^{2p}, for example, can be based on a reduced number of twiddle factors stored on die as compared to all twiddle factors to be used for NTT or iNTT computations for the N-degree polynomial. For example, see example powers of 2 for ω^{2p} for 128K-degree, 16K-degree or 16-degree polynomials in FIG. 3.

In some examples, logic flow 900 at 906 can generate the twiddle factor using the obtained data for ω^{2p} based, at least in part, on the received information. For example, the instruction that provided the information to generate the twiddle factor may be in example TWNTT/TWiNTT format 700 and memory address information included in the instruction can be used to obtain data for ω^{2p} that can be used to generate the twiddle factor.

The logic flow shown in FIG. 9 can be representative of example methodologies for performing novel aspects described in this disclosure. While, for purposes of simplicity of explanation, the one or more methodologies shown herein are shown and described as a series of acts, those skilled in the art will understand and appreciate that the methodologies are not limited by the order of acts. Some acts can, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology can be required for a novel implementation.

A logic flow can be implemented in software, firmware, and/or hardware. In software and firmware embodiments, a software or logic flow can be implemented by computer executable instructions stored on at least one non-transitory computer readable medium or machine readable medium, such as an optical, magnetic or semiconductor storage. The embodiments are not limited in this context.

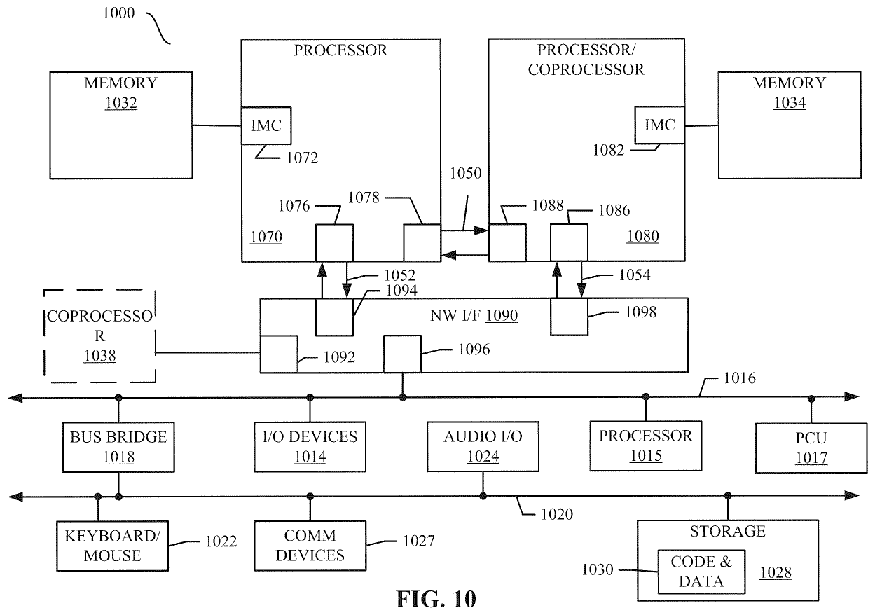

FIG. 10 illustrates an example computing system. Multiprocessor system 1000 is an interfaced system and includes a plurality of processors or cores including a first processor 1070 and a second processor 1080 coupled via an interface 1050 such as a point-to-point (P-P) interconnect, a fabric, and/or bus. In some examples, the first processor 1070 and the second processor 1080 are homogeneous. In some examples, first processor 1070 and the second processor 1080 are heterogenous. Though the example system 1000 is shown to have two processors, the system may have three or more processors, or may be a single processor system. In some examples, the computing system is a system on a chip (SoC).

Processors 1070 and 1080 are shown including integrated memory controller (IMC) circuitry 1072 and 1082, respectively. Processor 1070 also includes interface circuits 1076 and 1078; similarly, second processor 1080 includes interface circuits 1086 and 1088. Processors 1070, 1080 may exchange information via the interface 1050 using interface circuits 1078, 1088. IMCs 1072 and 1082 couple the processors 1070, 1080 to respective memories, namely a memory 1032 and a memory 1034, which may be portions of main memory locally attached to the respective processors.

Processors 1070, 1080 may each exchange information with a network interface (NW I/F) 1090 via individual interfaces 1052, 1054 using interface circuits 1076, 1094, 1086, 1098. The network interface 1090 (e.g., one or more of an interconnect, bus, and/or fabric, and in some examples is a chipset) may optionally exchange information with a coprocessor 1038 via an interface circuit 1092. In some examples, the coprocessor 1038 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1070, 1080 or outside of both processors, yet connected with the processors via an interface such as P-P interconnect, such that either or both processors' local cache information may be stored in the shared cache if a processor is placed into a low power mode.

Network interface 1090 may be coupled to a first interface 1016 via interface circuit 1096. In some examples, first interface 1016 may be an interface such as a Peripheral Component Interconnect (PCI) interconnect, a PCI Express interconnect or another I/O interconnect. In some examples, first interface 1016 is coupled to a power control unit (PCU) 1017, which may include circuitry, software, and/or firmware to perform power management operations with regard to the processors 1070, 1080 and/or co-processor 1038. PCU 1017 provides control information to a voltage regulator (not shown) to cause the voltage regulator to generate the appropriate regulated voltage. PCU 1017 also provides control information to control the operating voltage generated. In various examples, PCU 1017 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1017 is illustrated as being present as logic separate from the processor 1070 and/or processor 1080. In other cases, PCU 1017 may execute on a given one or more of cores (not shown) of processor 1070 or 1080. In some cases, PCU 1017 may be implemented as a microcontroller (dedicated or general-purpose) or other control logic configured to execute its own dedicated power management code, sometimes referred to as P-code. In yet other examples, power management operations to be performed by PCU 1017 may be implemented externally to a processor, such as by way of a separate power management integrated circuit (PMIC) or another component external to the processor. In yet other examples, power management operations to be performed by PCU 1017 may be implemented within BIOS or other system software.

Various I/O devices 1014 may be coupled to first interface 1016, along with a bus bridge 1018 which couples first interface 1016 to a second interface 1020. In some examples, one or more additional processor(s) 1015, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1016. In some examples, second interface 1020 may be a low pin count (LPC) interface. Various devices may be coupled to second interface 1020 including, for example, a keyboard and/or mouse 1022, communication devices 1027 and storage circuitry 1028. Storage circuitry 1028 may be one or more non-transitory machine-readable storage media as described below, such as a disk drive or other mass storage device which may include instructions/code and data 1030 and may implement the storage ‘ISAB03 in some examples. Further, an audio I/O 1024 may be coupled to second interface 1020. Note that other architectures than the point-to-point architecture described above are possible. For example, instead of the point-to-point architecture, a system such as multiprocessor system 1000 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

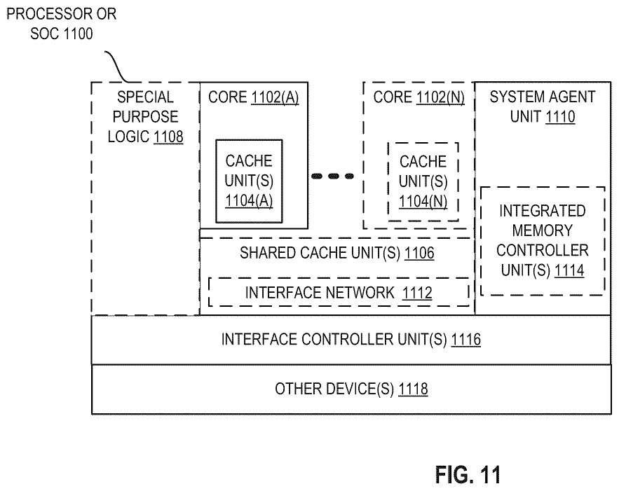

FIG. 11 illustrates a block diagram of an example processor and/or SoC 1100 that may have one or more cores and an integrated memory controller. The solid lined boxes illustrate a processor 1100 with a single core 1102(A), system agent unit circuitry 1110, and a set of one or more interface controller unit(s) circuitry 1116, while the optional addition of the dashed lined boxes illustrates an alternative processor 1100 with multiple cores 1102(A)-(N), a set of one or more integrated memory controller unit(s) circuitry 1114 in the system agent unit circuitry 1110, and special purpose logic 1108, as well as a set of one or more interface controller units circuitry 1116. Note that the processor 1100 may be one of the processors 1070 or 1080, or co-processor 1038 or 1015 of FIG. 10.

Thus, different implementations of the processor 1100 may include: 1) a CPU with the special purpose logic 1108 being integrated graphics and/or scientific (throughput) logic (which may include one or more cores, not shown), and the cores 1102(A)-(N) being one or more general purpose cores (e.g., general purpose in-order cores, general purpose out-of-order cores, or a combination of the two); 2) a coprocessor with the cores 1102(A)-(N) being a large number of special purpose cores intended primarily for graphics and/or scientific (throughput); and 3) a coprocessor with the cores 1102(A)-(N) being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1104(A)-(N) within the cores 1102(A)-(N), a set of one or more shared cache unit(s) circuitry 1106, and external memory (not shown) coupled to the set of integrated memory controller unit(s) circuitry 1114. The set of one or more shared cache unit(s) circuitry 1106 may include one or more mid-level caches, such as level 2 (L2), level 3 (L3), level 4 (L4), or other levels of cache, such as a last level cache (LLC), and/or combinations thereof. While in some examples interface network circuitry 1112 (e.g., a ring interconnect) interfaces the special purpose logic 1108 (e.g., integrated graphics logic), the set of shared cache unit(s) circuitry 1106, and the system agent unit circuitry 1110, alternative examples use any number of well-known techniques for interfacing such units. In some examples, coherency is maintained between one or more of the shared cache unit(s) circuitry 1106 and cores 1102(A)-(N). In some examples, interface controller units circuitry 1116 couple the cores 1102 to one or more other devices 1118 such as one or more I/O devices, storage, one or more communication devices (e.g., wireless networking, wired networking, etc.), etc.

In some examples, one or more of the cores 1102(A)-(N) are capable of multi-threading. The system agent unit circuitry 1110 includes those components coordinating and operating cores 1102(A)-(N). The system agent unit circuitry 1110 may include, for example, power control unit (PCU) circuitry and/or display unit circuitry (not shown). The PCU may be or may include logic and components needed for regulating the power state of the cores 1102(A)-(N) and/or the special purpose logic 1108 (e.g., integrated graphics logic). The display unit circuitry is for driving one or more externally connected displays.

The cores 1102(A)-(N) may be homogenous in terms of instruction set architecture (ISA). Alternatively, the cores 1102(A)-(N) may be heterogeneous in terms of ISA; that is, a subset of the cores 1102(A)-(N) may be capable of executing an ISA, while other cores may be capable of executing only a subset of that ISA or another ISA.

The following examples pertain to additional examples of technologies disclosed herein.

Example 1. An example apparatus can include a memory and circuitry resident on a same die or same chip as the memory. The circuitry can be configured to receive information to generate a twiddle factor for use by a compute element arranged to execute an NTT or an iNTT computation for an N-degree polynomial, where N is any positive integer. The circuitry can also be configured to obtain data for a power of 2 of a root of unity (ω^{2p}) from the memory, where p is any positive or negative integer. The circuitry can also be configured to generate the twiddle factor using the obtained data for ω^{2p} based, at least in part, on the received information.

Example 2. The apparatus of example 1, the compute element can be one compute element among a plurality of compute elements included in a tile that is one tile among a plurality of tiles. The tile can be arranged to execute a current stage number of an NTT or an iNTT operation from among a plurality of sequential stage numbers. A total of sequential stage numbers included in the plurality of sequential stage numbers can be determined based on LOG (2,N).

Example 3. The apparatus of example 2, the received information can indicate that the generated twiddle factor is to be an updated twiddle factor. The circuitry can also be configured to use a stage specific factor to determine what data for ω^{2p} to obtain from the memory, the stage specific factor determined based on 2^{LOG(N,2)-1-s} for an NTT operation or −2^{LOG (N,2)-1-s} for an iNTT operation, where s is the current stage number. The data for ω^{2p} can be determined based on replacing 2p with n, to result in ωⁿ, where n is the determined stage specific factor. The circuitry can also be configured to generate the updated twiddle factor based on multiplying ωⁱⁿ by ωⁿ, where ωⁱⁿ is a previously generated twiddle factor.

Example 4. The apparatus of example 3, the received information that indicates the generated twiddle factor can be an updated twiddle factor can also indicate the current stage number of the NTT or the iNTT operation, a first memory address of the memory to obtain data for ωⁱⁿ, and a second memory address of the memory to obtain data for ωⁿ.

Example 5. The apparatus of example 2, the received information can indicate that the generated twiddle factor is to not be an updated twiddle factor. The circuitry can also be configured to generate the twiddle factor based on multiplying ω⁰ by ωⁱⁿ, where ωⁱⁿ is a previously generated twiddle factor.

Example 6. The apparatus of example 5, the received information that can indicate the generated twiddle factor is to not be an updated twiddle factor can also indicates a first memory address of the memory to obtain data for ωⁿ and a second memory address of the memory to obtain data for ω⁰.

Example 7. The apparatus of example 2, the information to generate the twiddle factor can be included in an instruction sent to a parallel processing device that includes the plurality of tiles to enable a real time generation of the twiddle factor for use by the compute element.

Example 8. The apparatus of example 1, the compute element can be a DiT or a DiF butterfly circuit to generate 2 outputs based on 2 inputs to execute the NTT or the iNTT computation.

Example 9. An example method can include receiving information to generate a twiddle factor for use by a compute element arranged to execute an NTT or an iNTT computation for an N-degree polynomial, where N is any positive integer. The method can also include obtaining data for a power of 2 of a root of unity (ω^{2p}) from a memory resident on a same die or same chip as the compute element, where p is any positive or negative integer. The method can also include generating the twiddle factor using the obtained data for ω^{2p} based, at least in part, on the received information.

Example 10. The method of example 9, the compute element can be one compute element among a plurality of compute elements included in a tile that is one tile among a plurality of tiles. The tile can be arranged to execute a current stage number of an NTT or an iNTT operation from among a plurality of sequential stage numbers. A total of sequential stage numbers included in the plurality of sequential stage numbers can be determined based on LOG (2,N).

Example 11. The method of example 10, the received information indicating that the generated twiddle factor can be an updated twiddle factor, the method can further include using a stage specific factor to determine what data for ω^{2p} to obtain from the memory, the stage specific factor determined based on 2^{LOG(N,2)-1-s} for an NTT operation or −2^{LOG(N,2)-1-s} for an iNTT operation, where s is the current stage number. The data for ω^{2p} can be determined based on replacing 2p with n, to result in ωⁿ, where n is the determined stage specific factor. The method can also include generating the updated twiddle factor based on multiplying ωⁱⁿ by ωⁿ, where ωⁱⁿ is a previously generated twiddle factor.

Example 12. The method of example 11, the received information that indicates the generated twiddle factor can be an updated twiddle factor also indicates the current stage number of the NTT or the iNTT operation, a first memory address of the memory to obtain data for ωⁱⁿ, and a second memory address of the memory to obtain data for ωⁿ.

Example 13. The method of example 10, the received information indicating that the generated twiddle factor cannot be an updated twiddle factor, the method can further include generating the twiddle factor based on multiplying ω⁰ by ωⁱⁿ, where ωⁱⁿ is a previously generated twiddle factor.

Example 14. The method of example 13, the received information indicating that the generated twiddle factor cannot be an updated twiddle factor can also indicate a first memory address of the memory to obtain data for ωⁱⁿ and a second memory address of the memory to obtain data for ω⁰.

Example 15. The method of example 10, the information to generate the twiddle factor can be included in an instruction sent to a parallel processing device that includes the plurality of tiles to enable a real time generation of the twiddle factor for use by the compute element.

Example 16. The method of example 9, the compute element can be a DiT or a DiF butterfly circuit configured to generate 2 outputs based on 2 inputs to execute the NTT or the iNTT computation.

Example 17. An example at least one machine readable medium can include a plurality of instructions that in response to being executed by a system can cause the system to carry out a method according to any one of examples 9 to 16.

Example 18. An example apparatus can include means for performing the methods of any one of examples 9 to 16.

Example 19. An example system can include a memory, a compute element arranged to execute an NTT or an iNTT computation for an N-degree polynomial, where N is any positive integer, and circuitry resident on a same die or same chip as the memory and the compute element. The circuitry can be configured to receive information to generate a twiddle factor for use by the compute element arranged to execute the NTT or the iNTT computation for the N-degree polynomial. The circuitry can also be configured to obtain data for a power of 2 of a root of unity (ω^{2p}) from the memory, where p is any positive or negative integer. The circuitry can also be configured to generate the twiddle factor using the obtained data for ω^{2p} based, at least in part, on the received information.

Example 20. The system of example 19, the compute element can be one compute element among a plurality of compute elements included in a tile that can be one tile among a plurality of tiles resident on the same die or same chip as the memory. The tile can be arranged to execute a current stage number of an NTT or an iNTT operation from among a plurality of sequential stage numbers, a total of sequential stage numbers included in the plurality of sequential stage numbers determined based on LOG (2,N).

Example 21. The system of example 20, the received information can indicate that the generated twiddle factor is to be an updated twiddle factor. For this example, the circuitry can also be configured to use a stage specific factor to determine what data for ω^{2p} to obtain from the memory. The stage specific factor can be determined based on 2^{LOG(N,2)-1-s} for an NTT operation or −2^{LOG(N,2)-1-s} for an iNTT operation, where s is the current stage number. The data for ω^{2p} can be determined based on replacing 2p with n, to result in ωⁿ, where n is the determined stage specific factor. The circuitry can also be configured to generate the updated twiddle factor based on multiplying ωⁱⁿ by ωⁿ, where ωⁱⁿ is a previously generated twiddle factor.

Example 22. The system of example 21, the received information that can indicate the generated twiddle factor is to be an updated twiddle factor can also indicate the current stage number of the NTT or the iNTT operation, a first memory address of the memory to obtain data for ωⁱⁿ, and a second memory address of the memory to obtain data for ωⁿ.

Example 23. The system of example 20, the received information can indicate that the generated twiddle factor is to not be an updated twiddle factor. For this example, the circuitry can also configured to generate the twiddle factor based on multiplying ω⁰ by ωⁱⁿ, where ωⁱⁿ is a previously generated twiddle factor.

Example 24. The system of example 23, the received information that can indicate the generated twiddle factor is to not be an updated twiddle factor also can indicate a first memory address of the memory to obtain data for ωⁱⁿ and a second memory address of the memory to obtain data for ω⁰.

Example 25. The system of example 19, the information to generate the twiddle factor can be included in an instruction sent to the circuitry to enable a real time generation of the twiddle factor for use by the compute element.

Example 26. The system of example 19, the compute element can be a DiT or DiF butterfly circuit to generate 2 outputs based on 2 inputs to execute the NTT or the iNTT computation.

It is emphasized that the Abstract of the Disclosure is provided to comply with 37 C.F.R. Section 1.72 (b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

While various examples described herein could use the System-on-a-Chip or System-on-Chip (“SoC”) to describe a device or system having a processor and associated circuitry (e.g., Input/Output (“I/O”) circuitry, power delivery circuitry, memory circuitry, etc.) integrated monolithically into a single integrated circuit (“IC”) die, or chip, the present disclosure is not limited in that respect. For example, in various examples of the present disclosure, a device or system could have one or more processors (e.g., one or more processor cores) and associated circuitry (e.g., Input/Output (“I/O”) circuitry, power delivery circuitry, etc.) arranged in a disaggregated collection of discrete dies, tiles and/or chiplets (e.g., one or more discrete processor core die arranged adjacent to one or more other die such as memory die, I/O die, etc.). In such disaggregated devices and systems the various dies, tiles and/or chiplets could be physically and electrically coupled together by a package structure including, for example, various packaging substrates, interposers, interconnect bridges and the like. Also, these disaggregated devices can be referred to as a system-on-a-package (SoP).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a memory; and
circuitry resident on a same die or same chip as the memory, the circuitry configured to:
receive information to generate a twiddle factor for use by a compute element arranged to execute a number-theoretic-transform (NTT) or an inverse-NTT (INTT) computation for an N-degree polynomial, where N is any positive integer;
obtain data for a power of 2 of a root of unity (ω^{2p}) from the memory, where p is any positive or negative integer; and
generate the twiddle factor using the obtained data for ω^{2p} based, at least in part, on the received information.

2. The apparatus of claim 1, wherein the compute element is one compute element among a plurality of compute elements included in a tile that is one tile among a plurality of tiles, the tile arranged to execute a current stage number of an NTT or an iNTT operation from among a plurality of sequential stage numbers, a total of sequential stage numbers included in the plurality of sequential stage numbers determined based on LOG (2,N).

3. The apparatus of claim 2, the received information to indicate that the generated twiddle factor is to be an updated twiddle factor, the circuitry also configured to:
use a stage specific factor to determine what data for ω^{2p} to obtain from the memory, the stage specific factor determined based on 2^{LOG(N,2)-1-s} for an NTT operation or −2^{LOG(N,2)-1-s} for an iNTT operation, where s is the current stage number, the data for ω^{2p} determined based on replacing 2p with n, to result in ωⁿ, where n is the determined stage specific factor; and
generate the updated twiddle factor based on multiplying ωⁱⁿ by ωⁿ, where ωⁱⁿ is a previously generated twiddle factor.

4. The apparatus of claim 3, the received information that indicates the generated twiddle factor is to be an updated twiddle factor also indicates the current stage number of the NTT or the iNTT operation, a first memory address of the memory to obtain data for ωⁱⁿ, and a second memory address of the memory to obtain data for ωⁱⁿ.

5. The apparatus of claim 2, the received information to indicate that the generated twiddle factor is to not be an updated twiddle factor, the circuitry also configured to:
generate the twiddle factor based on multiplying ω⁰ by ωⁱⁿ, where ωⁱⁿ is a previously generated twiddle factor.

6. The apparatus of claim 5, the received information that indicates the generated twiddle factor is to not be an updated twiddle factor also indicates a first memory address of the memory to obtain data for ωⁱⁿ and a second memory address of the memory to obtain data for ω⁰.

7. The apparatus of claim 2, wherein the information to generate the twiddle factor is included in an instruction sent to a parallel processing device that includes the plurality of tiles to enable a real time generation of the twiddle factor for use by the compute element.

8. The apparatus of claim 1, wherein the compute element comprises a decimation-in-time (DiT) or a decimation-in-frequency (DiF) butterfly circuit to generate 2 outputs based on 2 inputs to execute the NTT or the iNTT computation.

9. A method comprising:
receiving information to generate a twiddle factor for use by a compute element arranged to execute a number-theoretic-transform (NTT) or an inverse-NTT (iNTT) computation for an N-degree polynomial, where N is any positive integer;
obtaining data for a power of 2 of a root of unity (ω^{2p}) from a memory resident on a same die or same chip as the compute element, where p is any positive or negative integer; and
generating the twiddle factor using the obtained data for ω^{2p} based, at least in part, on the received information.

10. The method of claim 9, wherein the compute element is one compute element among a plurality of compute elements included in a tile that is one tile among a plurality of tiles, the tile arranged to execute a current stage number of an NTT or an iNTT operation from among a plurality of sequential stage numbers, a total of sequential stage numbers included in the plurality of sequential stage numbers determined based on LOG(2,N).

11. The method of claim 10, the received information indicating that the generated twiddle factor is to be an updated twiddle factor, the method further comprising:
using a stage specific factor to determine what data for ω^{2p} to obtain from the memory, the stage specific factor determined based on 2 LOG^{(N,2)-1-s} for an NTT operation or −2 LOG^{(N,2)-1-s} for an iNTT operation, where s is the current stage number, the data for ω^{2p} determined based on replacing 2p with n, to result in ωⁿ, where n is the determined stage specific factor; and
generating the updated twiddle factor based on multiplying ωⁱⁿ by ωⁿ, where ωⁱⁿ is a previously generated twiddle factor.

12. The method of claim 11, the received information that indicates the generated twiddle factor is to be an updated twiddle factor also indicates the current stage number of the NTT or the iNTT operation, a first memory address of the memory to obtain data for ωⁱⁿ, and a second memory address of the memory to obtain data for ωⁿ.

13. The method of claim 10, the received information indicating that the generated twiddle factor is to not be an updated twiddle factor, the method further comprising:
generating the twiddle factor based on multiplying ω⁰ by ωⁱⁿ, where ωⁱⁿ is a previously generated twiddle factor.

14. The method of claim 13, the received information indicating that the generated twiddle factor is to not be an updated twiddle factor also indicates a first memory address of the memory to obtain data for ωⁱⁿ and a second memory address of the memory to obtain data for ω⁰.

15. The method of claim 10, wherein the information to generate the twiddle factor is included in an instruction sent to a parallel processing device that includes the plurality of tiles to enable a real time generation of the twiddle factor for use by the compute element.

16. The method of claim 9, wherein the compute element comprises a decimation-in-time (DiT) or a decimation-in-frequency (DiF) butterfly circuit configured to generate 2 outputs based on 2 inputs to execute the NTT or the iNTT computation.

17. An system comprising:
a memory;
a compute element arranged to execute a number-theoretic-transform (NTT) or an inverse-NTT (INTT) computation for an N-degree polynomial, where N is any positive integer; and
circuitry resident on a same die or same chip as the memory and the compute element, the circuitry configured to:
receive information to generate a twiddle factor for use by the compute element arranged to execute the NTT or the iNTT computation for the N-degree polynomial;
obtain data for a power of 2 of a root of unity (ω^{2p}) from the memory, where p is any positive or negative integer; and
generate the twiddle factor using the obtained data for ω^{2p} based, at least in part, on the received information.

18. The system of claim 17, wherein the compute element is one compute element among a plurality of compute elements included in a tile that is one tile among a plurality of tiles resident on the same die or same chip as the memory, the tile arranged to execute a current stage number of an NTT or an iNTT operation from among a plurality of sequential stage numbers, a total of sequential stage numbers included in the plurality of sequential stage numbers determined based on LOG(2,N).

19. The system of claim 18, the received information to indicate that the generated twiddle factor is to be an updated twiddle factor, the circuitry also configured to:
use a stage specific factor to determine what data for ω^{2p} to obtain from the memory, the stage specific factor determined based on 2^{LOG(N,2)-1-s} for an NTT operation or −2^{LOG(N,2)-1-s} for an iNTT operation, where s is the current stage number, the data for ω^{2p} determined based on replacing 2p with n, to result in ωⁿ, where n is the determined stage specific factor; and
generate the updated twiddle factor based on multiplying ωⁱⁿ by ωⁿ, where ωⁱⁿ is a previously generated twiddle factor.

20. The system of claim 19, the received information that indicates the generated twiddle factor is to be an updated twiddle factor also indicates the current stage number of the NTT or the iNTT operation, a first memory address of the memory to obtain data for ωⁱⁿ, and a second memory address of the memory to obtain data for ωⁿ.

21. The system of claim 18, the received information to indicate that the generated twiddle factor is to not be an updated twiddle factor, the circuitry also configured to:
generate the twiddle factor based on multiplying ω⁰ by ωⁱⁿ, where ωⁱⁿ is a previously generated twiddle factor.

22. The system of claim 21, the received information that indicates the generated twiddle factor is to not be an updated twiddle factor also indicates a first memory address of the memory to obtain data for ωⁱⁿ and a second memory address of the memory to obtain data for ω⁰.

23. The system of claim 17, wherein the information to generate the twiddle factor is included in an instruction sent to the circuitry to enable a real time generation of the twiddle factor for use by the compute element.

24. The system of claim 17, wherein the compute element comprises a decimation-in-time (DiT) or a decimation-in-frequency (DiF) butterfly circuit to generate 2 outputs based on 2 inputs to execute the NTT or the iNTT computation.
